(19) United States
(12) Patent Application Publication
(10) Pub. No.: US 2004/0004334 A1
(43) Pub. Date: Jan. 8, 2004

(54) Gardener carriage

(76) Inventor: Robert Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/187,001

(22) Filed: Jul. 2, 2002

(51) Int. Cl. B62B 3/00

(52) U.S. Cl. 280/47.34

(57) ABSTRACT

A gardener carriage has four wheel assemblies, at least two rectangular brackets each having four conical sleeves respectively and securely engaged with a corner of the bracket, four poles each connected to a corresponding one of the four wheel assemblies and composed of a first section and a second section screwingly connected to the first section and at least two clamping devices movably attached to the outer periphery of the pole. Each pole extends through a corresponding one of the conical sleeves such that the corresponding conical sleeve is able to enclose a corresponding one of the clamping devices on the pole so that the conical sleeve is supported and stopped by the corresponding clamping device and therefore the at least two rectangular brackets are supported.

### BACKGROUND OF THE INVENTION

1. Field of the Invention

The present invention relates to a gardener carriage, and more particularly to a gardener carriage which is easy to be assembled and disassembled by the user without any additional tools.

2. Description of Related Art

A conventional florist cart normally has a fixed structure so as to support thereon a heavy load. Using this kind of florist cart is convenient for the user because the structural integrity is secured. However, when the florist cart is moving to another location to proceed the gardening work, the user usually will have to spend a lot of time and effort trying to have this florist cart loaded on and unloaded from a truck. To avoid this inconvenience, the manufacturer introduced an improved florist cart assembly which is able to be disassembled into parts with proper tools and reassemble the parts to construct the florist cart. Again, using tools to proceed the assembly and disassembly of the florist cart seems troublesome to the user because the user will have to prepare the proper tools closeby even when the tools are not needed.

To overcome the shortcomings, the present invention tends to provide an improved gardener carriage to mitigate and obviate the aforementioned problems.

### SUMMARY OF THE INVENTION

The primary objective of the present invention is to provide an improved gardener carriage which is able to be assembled and disassembled easily without using any tools.

Another objective of the present invention is to provide a gardener carriage having a clamping device movably attached to poles of the gardener carriage so that position of a bracket is able to be adjusted relative to the gardener carriage.

In order to accomplish the foregoing objective, the gardener carriage of the present invention has four poles, two arms respectively mounted on top of the four poles and two brackets each movably connected with the four poles via a clamping device, wherein each pole has a first end provided with a wheel assembly securely connected to the first end of the pole and a second end connected to one distal end of the arms. The pole is composed of a first section and a second section and each of the first and second sections of the pole is provided with grooves. The first section of the pole has a first end provided with an inner threading corresponding to an outer threading on the wheel assembly so that the wheel assembly is able to screwingly connect to the first end of the first section of the pole. A conical sleeve is provided to enclose a joint of the wheel assembly and the first end of the first section. A conical clamping device composed of a first piece and a second piece has an annular flange formed inside an inner periphery of the first piece and the second piece to correspond to one of the grooves so that after the annular flange of the clamping device is received in the corresponding groove in the first section or the second section, the sleeve is able to enclose therein the clamping device and a bracket attached to a side face of the conical sleeve is supported by the pole.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of the gardener carriage of the present invention;

FIG. 2 is an exploded perspective view of a part of the gardener carriage;

FIG. 3 is a schematic view showing the engagement among the conical sleeve, the clamping device and the outer periphery of the pole of the gardener carriage of the present invention; and

FIG. 4 is a side plan view showing that a basin is supported by the upper bracket.

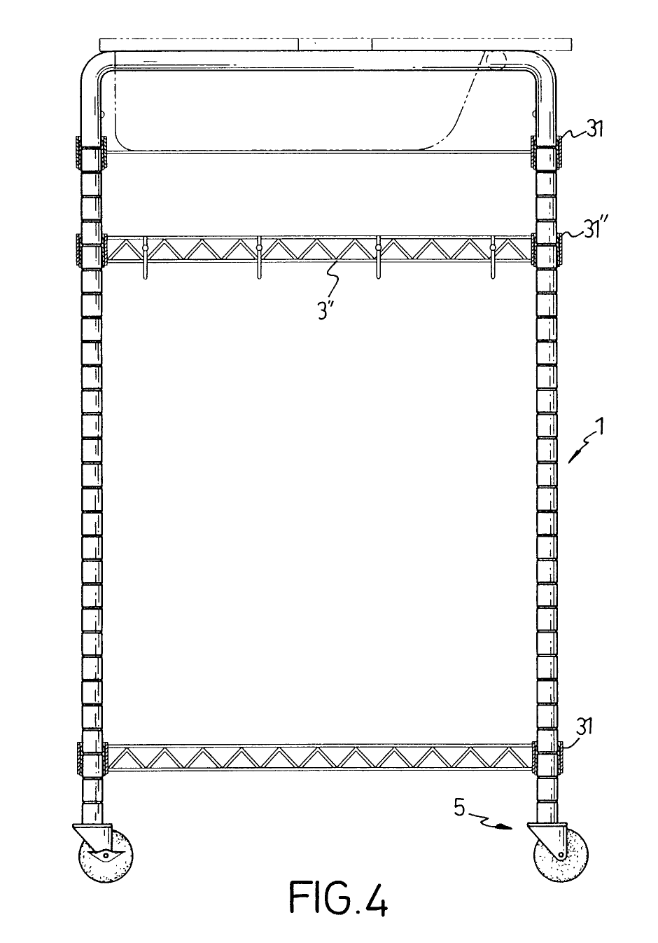

### DETAILED DESCRIPTION OF THE PREFERRED EMBODIMENT

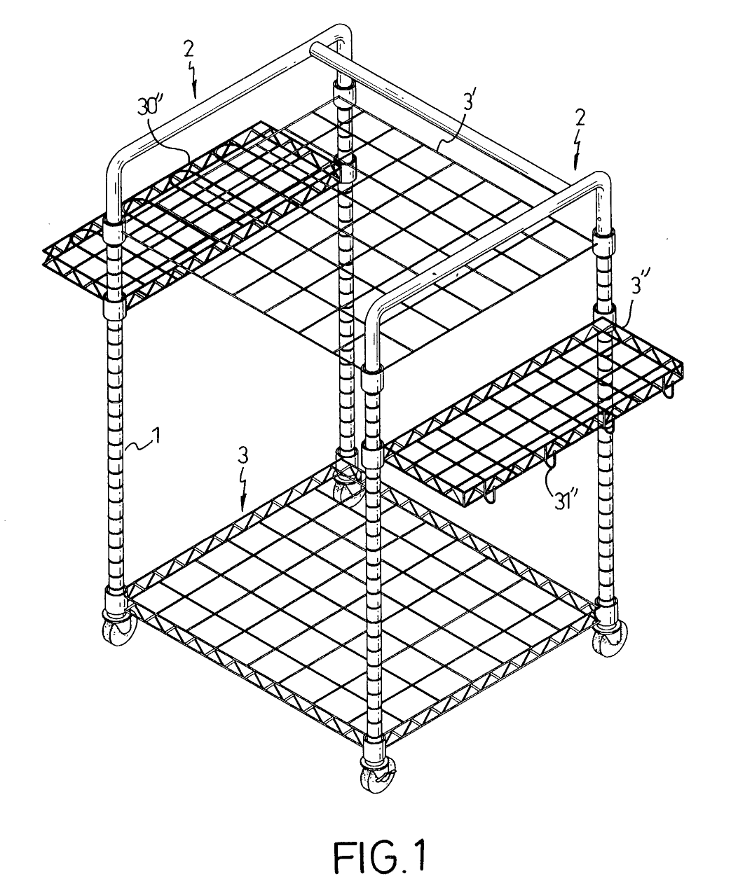

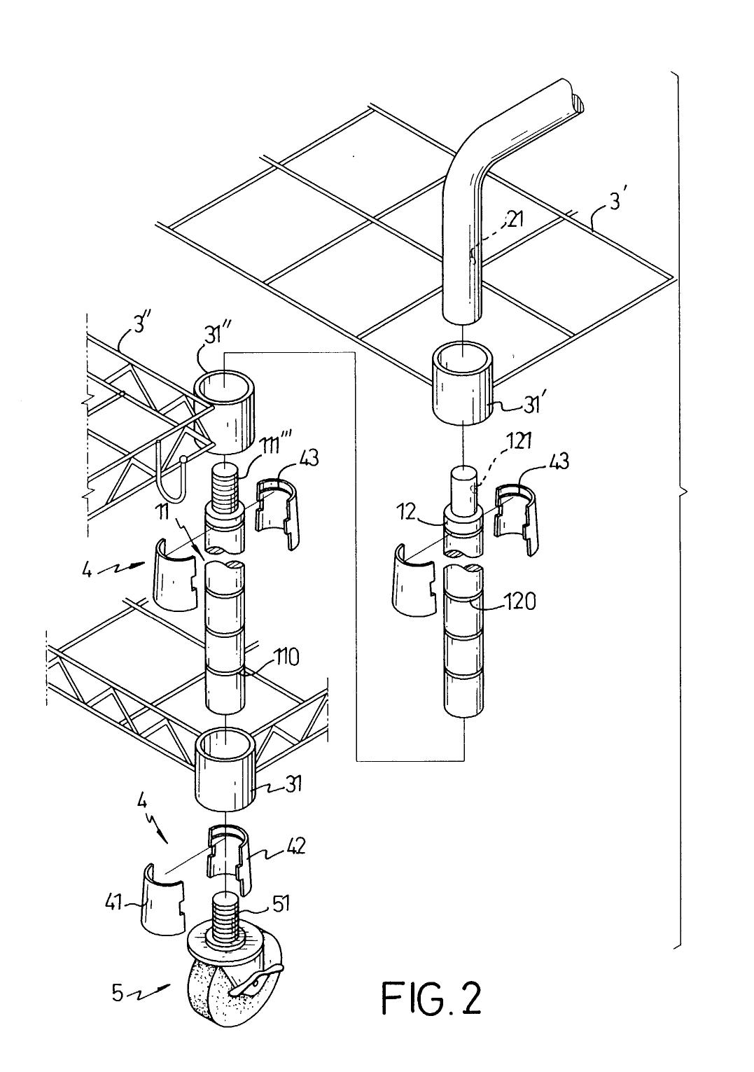

With reference to FIG. 1, the gardener carriage in accordance with the present invention has four poles (1), two arms (2) respectively mounted on top of the four poles (1) and two rectangular brackets (3,3′) each movably connected with the four poles (1) via a clamping device (4) (as shown in FIG. 2). It is noted that the gardener carriage of the present invention may be provided with a pair of braking system mounted on a pair of posts (1) to provide a braking effect to the gardener carriage.

With reference to FIG. 2, each pole (1) has a first end provided with a wheel assembly (5) securely connected to the first end of the pole (1) and a second end connected to one distal end of the arm (2). The pole (1) is composed of a first section (11) and a second section (12). Each first and second section (11,12) of the poles (1) is provided with grooves (110,120). The first section (11) of the pole (1) has a first end provided with an inner threading (not shown) corresponding to an outer threading (51) on the wheel assembly (5) so that the wheel assembly (5) is able to screwingly connect to the first end of the first section (11) of the pole (1).

A conical sleeve (31) securely engaged with a corner of the rectangular bracket (3) is provided to enclose a joint of the wheel assembly (5) and the first end of the first section (11). The conical clamping device (4) composed of a first piece (41) and a second piece (42) has an annular flange (43) formed inside an inner periphery of the first piece (41) and the second piece (42) to correspond to one of the grooves (110,120).

The second section (12) of the pole (1) has a first end provided with an inner threading (not shown) corresponding to an outer threading (111) on a second end of the first section (11) and a ball-spring combination (121) formed on a second end of the second section (12) to correspond to a hole (21) in a distal end of the arm (2). A second conical sleeve (31′) securely connected to a corner of a second rectangular bracket (3′) is provided to enclose a joint between the second end of the second section (12) and the distal end of the arm (2) so that the engagement between the ball-spring combination (121) and the distal end of the arm (2) is able to be covered by the second conical sleeve (31′).

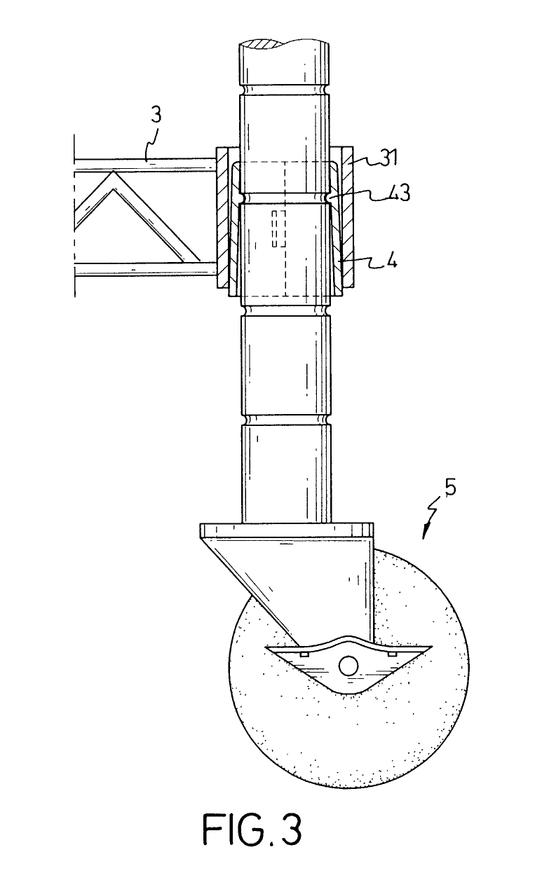

With reference to FIG. 3, when the gardener carriage of the present invention is to be assembled, the outer threading (51) of the wheel assembly (5) is screwed into the inner threading of the first section (11) of the pole (1) to securely engage the wheel assembly (5) to the pole (1). The first piece (41) and the second piece (42) of the clamping device (4) are applied to cover the engagement between the outer threading (51) and the inner threading of the first end of the first section (11) with the inner flange (110) received in a corresponding one of the grooves (110). Then, the second end of the first section (11) extends through the conical sleeve (31) to allow the conical sleeve (31) to cover the clamping device (4). Thereafter, the outer threading (111) of the second end of the first section (11) is screwed into the first end of the second section (12) to complete the engagement between the first section (11) and the second section (12). Then, another set of clamping device (4) is applied to enclose the engagement between the second end of the first section (11) and the first end of the second section (12) with the annular flange (43) received in a corresponding one of the grooves (110,120). After the assembly of the pole (1), a side bracket (3″) with a secondary conical sleeve (31″) securely attached to a corner of the side bracket (3″) is applied. The second end of the second section (12) extends through the secondary conical sleeve (31″) so that the secondary conical sleeve (31″) encases another clamping device (4) with its annular flange (43) received in a corresponding one of the grooves (110,120). It is to be noted that one of the side brackets (3″) has rings (30″) formed on a side face of the side bracket (3″) and hooks (31″) formed on the other side bracket (3″). With the rings (30″) and the hooks (31″), the user is able to hang such as gloves (not shown) and tools (not shown). Before the ball-spring combination (121) of the second end of the second section (12) is received in the corresponding hole (21) in the arm (2), the second end of the second section (12) extends through the conical sleeve (31″) of the bracket (3″) to allow the conical sleeve (31″) to engage with the clamping device (4) having its annular flange (43) received in a corresponding one of the grooves (120).

Referring to FIG. 1, it is to be noted that although the foregoing description concerning the assembly of the gardener carriage of the present invention focuses on the relationship between one pole (1) and one corner of the bracket (3) only, the assemblies of the other three poles (1) and other corners of the brackets (3′3″) are substantially the same. Therefore, detailed description in relation to the other poles (1), brackets (3′,3″) is omitted. However, there are two brackets (3,3′) respectively supported on bottoms and tops of the four poles (1). Further, two side brackets (3″) are supported on two adjacent poles (1) on opposite sides of the gardener carriage.

After the above assembly, the gardener carriage can be assembled and disassembled easily without the assistance of any tools. Furthermore, the relative heights of the brackets (3,3′) can be adjusted. That is, for example, when the adjustment of the relative height of the bracket (3) to the poles (1) is required, the user elevates the conical sleeve (31) to expose the clamping device (4). Then the user splits the clamping device (4) into the first piece (41) and the second piece (42) and moves the clamping device (4) to a proper position. After the annular flange (43) is received in a corresponding one of the grooves (110), the clamping device (4) is assembled and the conical sleeve (31) is again applied to cover the clamping device (4). Therefore, the user is able to randomly adjust the relative height of the bracket (3,3′,3″) to the poles (1) to adapt to the dimension of the object to be carried by the gardener carriage.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A gardener carriage comprising:
four wheel assemblies;
at least two rectangular brackets each having four conical sleeves respectively and securely engaged with one of four corners of the bracket;
four poles each connected to a corresponding one of the four wheel assemblies and composed of a first section and a section screwingly connected to the first section and at least two clamping devices movably attached to the outer periphery of the pole, wherein each pole extends through a corresponding one of the conical sleeves such that the corresponding conical sleeve is able to enclose a corresponding one of the clamping devices on the pole so that the conical sleeve is supported and stopped by the corresponding clamping device and therefore the at least two rectangular brackets are supported.

2. The gardener carriage as claimed in claim 1, wherein each pole has grooves defined in an outer periphery of the pole to correspond to an annular flange formed on an inner periphery of the clamping device so that the clamping device is able to be movable relative to the pole.

3. The gardener carriage as claimed in claim 1 further comprising two arms respectively and detachably connected to two adjacent poles, wherein each arm has a hole defined in two distal ends thereof to correspond to a ball-spring combination formed on a distal end of the pole so that the arms are able to detachably connected to the poles.

4. The gardener carriage as claimed in claim 2 further comprising two arms respectively and detachably connected to two adjacent poles, wherein each arm has a hole defined in two distal ends thereof to correspond to a ball-spring combination formed on a distal end of the pole so that the arms are able to detachably connected to the poles.

5. The gardener carriage as claimed in claim 1 further comprising two side brackets each oppositely and movably connected to two adjacent poles.

6. The gardener carriage as claimed in claim 2 further comprising two side brackets each oppositely and movably connected to two adjacent poles.

7. The gardener carriage as claimed in claim 4 further comprising two side brackets each oppositely and movably connected to two adjacent poles, wherein one side bracket has rings formed on a side face of the side bracket and the other side bracket has hooks formed on a side face of the other side bracket,
whereby the rings and the hooks are able to support florist tools.

8. The gardener carriage as claimed in claim 7, wherein each of the two side brackets has two secondary conical sleeves.
